(19) United States
(12) Patent Application Publication
(10) Pub. No.: US 2009/0106108 A1
(43) Pub. Date: Apr. 23, 2009

(54) WEBSITE MANAGEMENT METHOD AND ON-LINE SYSTEM

(76) Inventor: YOUNG BAE KU, Seocho-gu (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/253,549

(22) Filed: Oct. 17, 2008

(30) Foreign Application Priority Data
Oct. 22, 2007 (KR) 10-2007-0106176

(51) Int. Cl. G06Q 30/00; G06F 7/06; G06F 17/30

(52) U.S. Cl. 705/14; 707/3; 707/E17.108

(57) ABSTRACT

Provided is a website management method and system based on a search query. The website management method and system analyze behavior of clicking or purchasing a product or contents after a user inputs a search query on a website which provides information on products or contents or relays transactions, and dynamically updates a keyword group including a plurality of search queries having the same attribute information (category such as brand, theme, first-level classification, second-level classification, or third-level classification) in a database such that the search queries can be automatically managed.

### CROSS-REFERENCE TO RELATED APPLICATION

This application claims the benefit of Korean Patent Application No. 10-2007-0106176, filed Oct. 22, 2007, the disclosure of which is hereby incorporated herein by reference in its entirety.

### BACKGROUND OF THE INVENTION

1. Field of the Invention

The present invention relates to a target advertisement method and system based on a search query.

2. Description of Related Art

When browsing a website such as an online shopping mall, a user generally browses through products or contents searched-for by inputting a search query or provided when a category corresponding to a brand or theme under which the products or contents are classified is selected. Various advertisements are included in a webpage provided when a user inputs a search query or clicks and selects a product or contents belonging to a certain category. In general, the advertisements are composed of images related to the webpage.

For example, when a search query of ‘cosmetics’ is input or a cosmetic belonging to a certain category is clicked and selected to obtain detailed product information on an online shopping mall, various advertisements for products related to the cosmetic, such as perfume, gel, wax, liver spot remover, or women's underwear, as well as detailed information about the cosmetic can be displayed on the left and right sides or upper and lower sides of a corresponding webpage. Such advertisements may be composed of advertisement contents registered when an advertiser who wants to post an advertisement on the webpage purchases a related keyword.

In such an advertisement method, however, when an advertiser purchases a related search query, a registered advertisement is only displayed on a corresponding webpage. Thus, only when a user inputs the search query is the advertisement displayed. Consequently, the display frequency of the advertisement is low. For example, an advertiser of women's cosmetics may want an advertisement of his/her company to be displayed not only when a search query or a product within a category is ‘cosmetics’, but also when a user inputs a search query of ‘woman’, ‘skin’, ‘massage’, ‘gift’, ‘women's clothes’, or ‘underwear’, or a corresponding product is clicked. Such an advertiser who wants an advertisement of his/her company to be frequently displayed as a search result of a related query keyword or a product information webpage should purchase as many related search queries as possible. Further, the advertisement display frequency differs according to whether a search query is popular or not, and a popular search query is more expensive than an unpopular search query. Further, a specific search query may be frequently purchased, causing advertisement orders to crowd a specific webpage.

### SUMMARY OF THE INVENTION

The present invention is directed to a website management method and system that analyze behavior of clicking or purchasing a product or contents after a user inputs a search query, and dynamically update a keyword group including a plurality of search queries having the same attribute information (category such as brand, theme, first-level classification, second-level classification, or third-level classification) in a database such that the search queries can be automatically managed, in order to receive an advertisement order for a category representing all search queries belonging to a keyword group and to display an advertisement whenever queries belonging to the corresponding category are input or information on products or contents is requested on a website which provides information on products or contents or relays transactions.

The present invention is also directed to a website management method and system that can count search queries input by users on a website such as a shopping mall such that a predetermined number of popular search queries are automatically managed, can allocate popular search queries to a category with a predetermined period (for example, every week) according to attribute information such that the category which reflects users' search query input tendencies is automatically managed, and can manage categories according to the sex, age, or residence of users such that when an advertiser purchases a desired category, an advertisement can be automatically displayed with a high frequency on a webpage related to all keyword groups which are not concentrated on some popular search queries belonging to the corresponding category.

In one aspect, a website management method includes: receiving a search query and then analyzing browsing behavior for an information request for contents belonging to a certain category until another search query is input; and determining a category to which the received search query belongs.

In another aspect, a website management method includes: determining a keyword group including a plurality of search queries which each belong to any one of a plurality of categories one time; selling all the search queries belonging to the keyword group to at least one advertiser in units of categories; and when a search query within a sold category is input or contents within a sold category are selected, providing advertisement contents registered when the category is sold on a corresponding webpage.

In still another aspect, a website management method includes: receiving a search query; providing a search result webpage for the search query; selecting contents on the webpage at least one time; providing a detailed information webpage of the selected contents; determining a category to which the selected contents belong and then totaling the number of inquires for the category; and totaling the numbers of contents inquires for the plurality of search queries, periodically classifying the plurality of search queries into keyword groups, and allocating the search queries to the respective categories.

In yet another aspect, an online system includes an online server that manages a webpage on the Internet, the online server including a controller which receives a search query, analyzes browsing behavior for an information request for contents belonging to a certain category until another search query is input, and determines a category to which the search query belongs.

In yet another aspect, an online market system includes: a search engine that receives a search query and provides a search result webpage for the search query; a transaction relay that provides a detailed information webpage of a product when the product is selected on the webpage; and a keyword group manager that determines a category to which the selected product belongs and then totals the number of product inquiries for the corresponding category. The keyword group manager totals the numbers of product inquiries for the plurality of search queries, periodically classifies the plurality of search queries as a keyword group, and allocates the search queries to the respective categories.

### BRIEF DESCRIPTION OF THE DRAWINGS

The above and other objects, features and advantages of the present invention will be more apparent from the following detailed description taken in conjunction with the accompanying drawings, in which:

FIG. 1 is a flowchart for explaining a website management method according to an example embodiment of the present invention;

FIG. 2 is a diagram for explaining a product group for each category of an online market according to the present invention;

FIG. 3 is a diagram for explaining the number of product inquiries for each category 110 which is estimated by behavior analysis according to the present invention;

FIG. 4 is a diagram for explaining an example of a keyword group for each category according to the present invention;

FIG. 5 is a diagram for explaining a process of analyzing behavior on an online market according to the present invention;

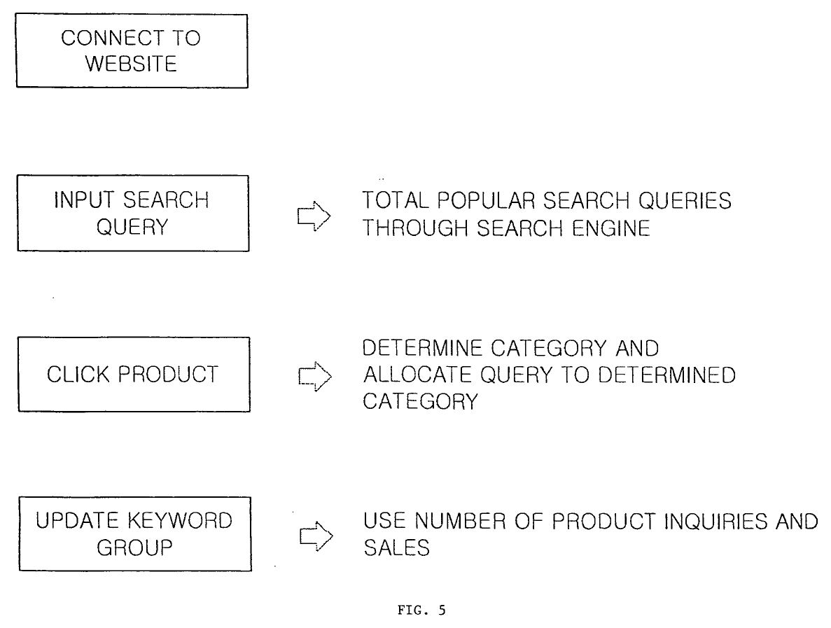

FIG. 6 is a diagram for explaining a process of determining a category for a popular search query according to the present invention;

FIG. 7 is a diagram for explaining an online market system according to an example embodiment of the present invention;

FIG. 8 is a block diagram of an online market server according to the present invention;

FIG. 9 is a diagram for explaining a process of determining a category by totaling the number of product inquiries for a search keyword;

FIG. 10 is a diagram for explaining a process of purchasing a keyword group for advertisement; and

FIG. 11 is a diagram for explaining a process of exposing an advertisement for a purchase keyword group.

### DETAILED DESCRIPTION OF EXEMPLARY EMBODIMENTS

Hereinafter, example embodiments of the present invention will be described in detail with reference to the accompanying drawings. However, the scope of the present invention is not limited to the example embodiments. Like elements are denoted by like reference numerals throughout the drawings.

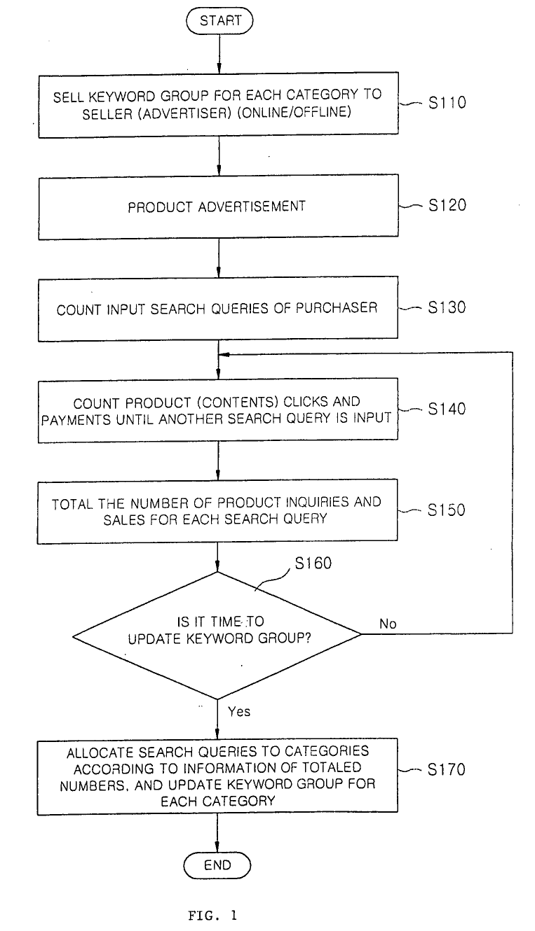

FIG. 1 is a flowchart for explaining a website management method according to an example embodiment of the present invention. In the present invention, when products or contents shown as a result of inputting a search query are browsed through on an Internet website such as an on-line market (shopping mall or the like), categories for a plurality of search queries are determined based on the number of inquires for the products or contents. Further, a keyword group of search queries which belong to each category and are managed so as to be dynamically updated is sold to an advertiser such that advertisement contents registered by the advertiser can be displayed along with search results or webpages when products or contents shown by selecting the category are browsed through. Therefore, the advertisement contents can be automatically displayed with a high frequency.

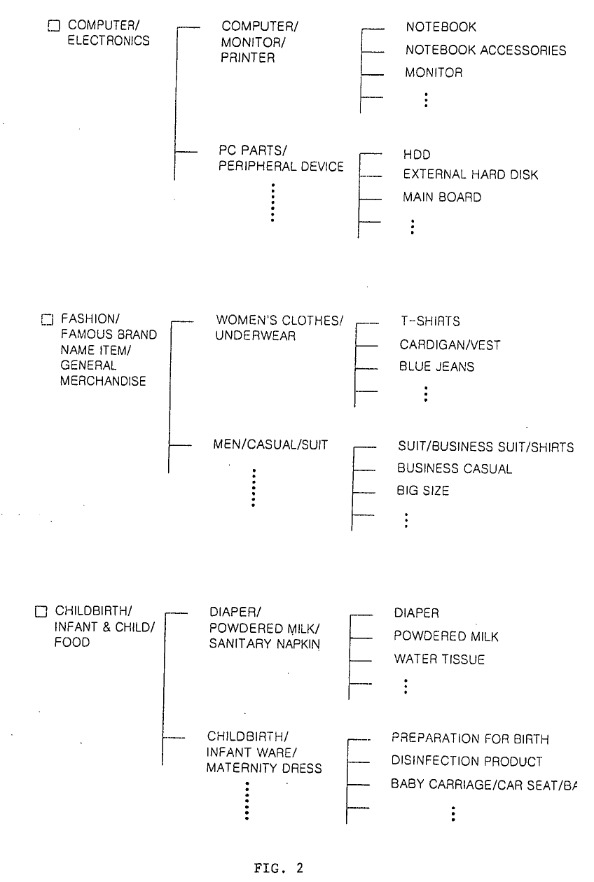

Therefore, browsing behavior after input of a search query is analyzed to determine a category to which the search query belongs. The analysis of the browsing behavior means an analysis of an information request for contents which belong to a certain category after one search query is input until another search query is input. For example, when products and contents displayed on a search result webpage are browsed through, a category which is classified into various sub-categories as shown in FIG. 2 and to which the products and contents belong can be determined on a website such as an on-line shopping mall. As shown in FIG. 2, a category which is attribute information for classifying products and contents may have a first-level classification (for example, computers/electronics), a second-level classification (for example, computers/monitors, printers) under the first-level classification, and a third-level classification (for example, notebooks) under the second-level classification. Further, the category may have several stages of sub-categories under the third-level classification, if necessary.

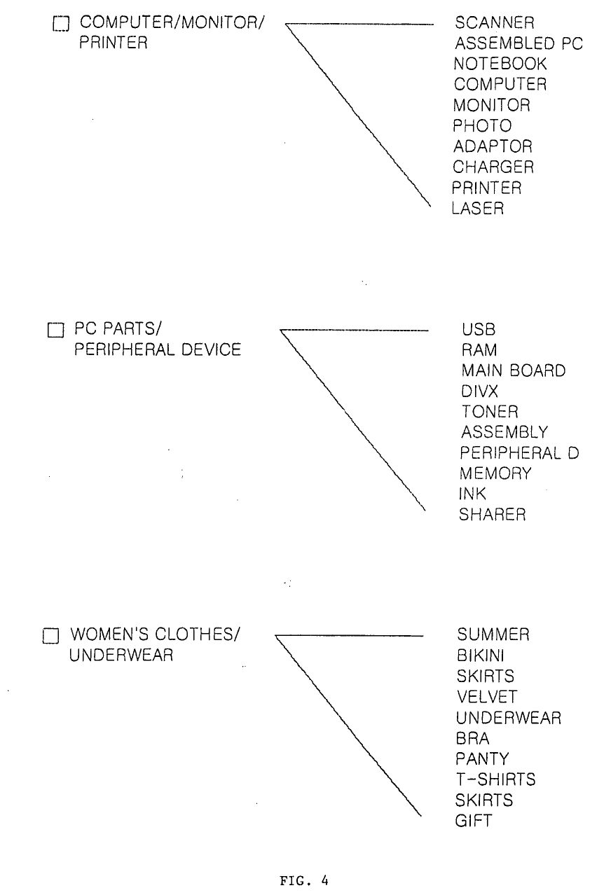

Through the analysis of browsing behavior, the numbers of inquires for products or contents after the input of popular search queries are automatically totaled, and a category for a corresponding search query can be determined-based on the order of the numbers of inquires. For example, in FIG. 2, a search result displayed by inputting a search query of ‘notebook’ shows that information on products and contents of the ‘computer/electronics’ category is requested. Therefore, the search query of ‘notebook’ is allocated to the ‘computer/electronics’ category. In this way, a plurality of search queries can be each allocated to a specific category, according to how many times products and contents belonging to a certain category are requested after the search query is input. As will be described below, the search query or popular search query may include a word or phrase such as ‘summer’ or ‘gift’, which can be input to search for a product or contents as shown in FIG. 4, as well as a word or phrase such as ‘notebook’, which directly indicates a product or contents.

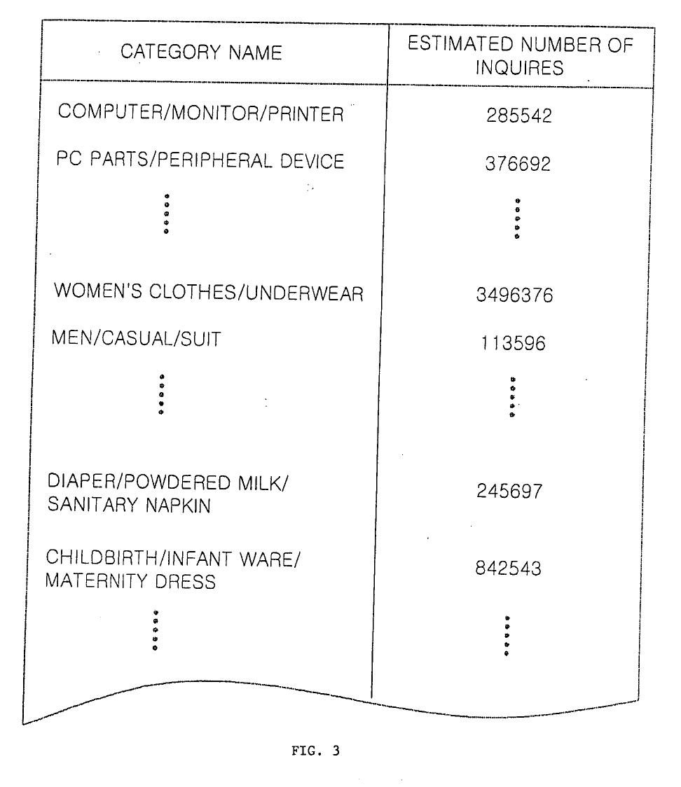

At this time, when information on a product or contents displayed on the search result is requested, the numbers of inquires for products and contents can be estimated for the respective categories and totaled as shown in FIG. 3. For example, a keyword group including a predetermined number (for example, ten) of popular search queries with a high-ranked inquiry number is determined for each category, as shown in FIG. 4. Whenever information on a product or contents of the category to which the keyword group belongs is requested, the number of inquires is totaled for the category. Further, the numbers of inquires are estimated and totaled, as shown in FIG. 3. A keyword group of each category can be updated with a predetermined period, for example, every week. Further, each search query within a keyword group of one category may be classified so as not to belong to a keyword group of another category.

When an advertiser (seller or the like) wants to purchase all search queries belonging to a category, that is, a keyword group in accordance with the management of keyword group for each category, in order to advertise products or contents, search queries belonging to a keyword group for each category as shown in FIG. 4 can be presented so as to be referred to for the purchasing of the category. The advertiser can purchase all search queries belonging to a corresponding category, that is, a keyword group, online or offline by referring to the data indicated in FIGS. 3 and 4.

As such, all search queries belonging to a keyword group can be sold to an advertiser in units of categories. In this case, one category can be sold to a plurality of advertisers (step S110). When a search query belonging to the sold category is input or a product or contents is selected on a website such as an online shopping mall, advertisement contents registered when the category is sold to the advertiser can be provided (step S120). The advertisement contents registered when the category is sold to the advertiser may be multimedia data such as text, image, or moving image data. The advertisement contents may be displayed at a proper position on a webpage.

In this specification, an Internet site such as an online shopping mall, which relays the transactions of products, is taken as an example. Without being limited thereto, however, the website management method can be applied to all the Internet sites which provide a search service, manage contents by classifying the contents for each category (including brand, theme, first-level classification, second-level classification, third-level classification, and so on), and receive an order for advertisement on a webpage while managing the sale of the contents, if necessary. For example, the website management method for managing and selling keyword groups according to the present invention can be applied to all sites which manage news, newspapers, bulletin boards, games, blogs, cafes, and other contents.

Meanwhile, even while the advertisement registered by the advertiser is displayed on the corresponding webpage, a process of analyzing browsing behavior after input of a search query to determine a category to which the search query belongs, through steps S130 to 170, and dynamically allocating and updating a keyword group for each category, is repeatedly performed.

A user such as a purchaser having a membership to an online shopping mall can log in to browse the shopping mall. When the user logs in, user information input when the user joined the site, for example, sex, age, residence, marital status and so on, may be traced. The user information can be basically used for totaling the number of inquires such that a category can be suggested and sold to each user, as will be described below. In order to purchase a product, the user connected to the online shopping mall can click the product displayed on a webpage while selecting a category to move on to a lower stage. In the present invention, however, browsing behavior after a user inputs a search query in a predetermined search window is analyzed.

First, whenever a search query is input and a search result is provided by a predetermined search engine, the number of input search queries can be counted (step S130). The counting of the number of input search queries is performed with a predetermined period to manage popular search queries by gathering statistics of input tendencies of users based on the input number, as will be described below.

Meanwhile, browsing behavior of the user after the input of the search query is analyzed. That is, an information request for contents belonging to a certain category is analyzed after the search query is input until another search query is input. For this analysis, when a search result webpage is provided on the online shopping mall, the number of clicks for a certain product on the webpage can be counted. Further, when a detailed information webpage of the product after the click is provided and a payment for the product is made, the number of payments can also be counted (step S140). As described above, a category to which a product clicked after input of a search query (particularly a popular search query) belongs is determined through the browsing behavior analysis. Then, the number of inquires for the product belonging to the category is totaled, and the sales of the category to which the product belongs can be totaled (step S150). The process of counting the number of clicks for a product to total the number of inquires for the product and counting the number of payments to total the sales is repeatedly performed until another search query is input.

The process of analyzing browsing behavior is also repeatedly performed even when another search query is input, and a keyword group belonging to a category is updated with a predetermined period, for example, every Sunday morning (step S160). That is, the number of inquiries for a product is automatically totaled for a plurality of popular search queries, and the plurality of popular search queries are periodically classified into keyword groups so as to be allocated to the respective categories (step S170). The search queries may be classified in such a manner that a search query of one keyword group does not belong to another keyword group within a different category. The information obtained by totaling the sales according to the payments can be used for assigning a weight when a corresponding search query is allocated to a category.

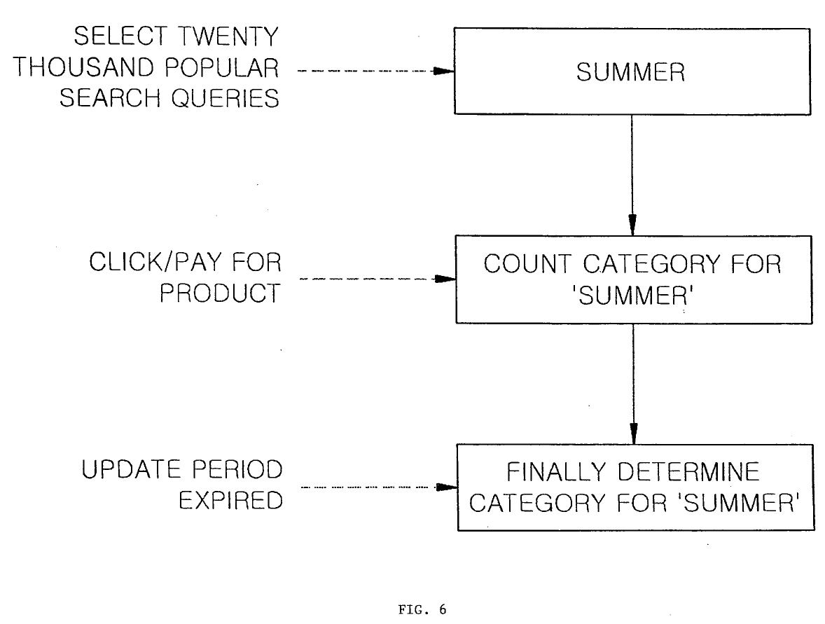

For example, when a search query of ‘summer’, one predetermined popular search query, is input as shown in FIG. 6, the number of input search queries is counted as in step S130, and the popular search queries can be updated dynamically with a predetermined period, for example, every week, based on the number of input search queries. That is, in the current week, the search query of ‘summer’ may be a high-rank popular search query (for example, one of twenty thousand search queries). However, when users do not use the search query frequently, it may be excluded from the popular search queries the following week. Further, search queries restricted by the management of the popular search queries, for example, sexual or obscene words or phrases which may be offensive to the public, may be excluded from the search query counting for selecting popular search queries.

Thereafter, when users frequently click products corresponding to a category of ‘women's clothes/underwear’, for example, T-shirts, cardigan, and blue jeans, on the search result webpage for the search query of ‘summer’, the search query of ‘summer’ is dynamically allocated as a search query belonging to a keyword group of the category of ‘women's clothes/underwear’ according to the numbers of product inquiries for the category, as shown in FIG. 4. Further, search queries of ‘bikini’, ‘skirts’, ‘velvet’ and so on as well as the search query of ‘summer’ can be allocated as search queries belonging to the keyword group of the category of ‘women's clothes/underwear’, as shown in FIG. 4. Further, the order of search queries of ‘summer’, ‘bikini’, ‘skirts’, ‘velvet’, . . . , ‘gift’, which is determined according to the numbers of inquires for products belonging to the search queries, can be presented to an advertiser. At this time, to prevent a case in which the number of inquires is made up by repeatedly inputting a predetermined word or phrase through an automatic system or manual labor, when a product is clicked more than several tens of times, for example, fifty times, the number of inquires for the product may no longer be counted.

As mentioned briefly above, when payment is made on a detailed information webpage of a product, the sales of the product may be totaled so as to assign a weight when a corresponding search query (input before the product is clicked) is allocated to a category. For example, after the search query of ‘summer’ belonging to the keyword group of the category of ‘women's clothes/underwear’ is input, a product belonging to the category of ‘women's clothes/underwear’ may be sold. In this case, to reflect actual shopping behavior of a logged-in user, a predetermined quantity, for example, 1, may be added to the number of product inquiries for the category. Further, according to the sales of a product, a predetermined quantity may be added to the number of product inquiries for a corresponding category.

Through such a process, the numbers of product inquiries for each category may be totaled for a predetermined number of popular search queries. According to the total information, the popular search queries may be classified into keyword groups so as to be allocated to the respective categories. Further, the popular search queries are periodically updated and managed by repeatedly performing the same process. As described in step S110, all search queries belonging to a keyword group managed in such a manner can be sold to several advertisers in units of categories.

When a category (including all search queries belonging to a keyword group) is sold to an advertiser, the result obtained by counting the number of product inquiries for each category, which is estimated as shown in FIG. 3, and a keyword group including ten popular search queries which belong to a certain category and of which the inquiry numbers are raked high, may be presented as shown in FIG. 4. By referring to the presented information, the advertiser can purchase all the search queries belonging to a category, that is, a keyword which is closely related to products and contents of the advertiser.

After all the search queries belonging to such a keyword group are sold to the advertiser in units of categories, and when a search query belonging to the sold category is received through a predetermined search window of the corresponding site, advertisement contents registered when the category is sold, for example, various multimedia data such as text, image, or moving image data can be provided at a proper position on a corresponding search result webpage. Further, even when contents within the sold category are selected on the search result webpage or a webpage displaying contents within another category, the advertisement contents registered when the category is sold may be provided on a detailed information webpage of the contents. Therefore, the display frequency of the advertisement contents can be increased. Accordingly, since Internet users who are frequently displayed the same advertisement may have a favorable impression of the advertisement, sales of a product or contents can be increased.

Further, when a user logs in, the number of product inquiries is counted based on user information corresponding to the log in, and a plurality of search queries can be allocated to each category. For example, browsing behavior after the input of the search query is analyzed according to the sex, age, residence, and marital status of logged-in users. Then, a keyword group including the plurality of search queries may be allocated to each category according to the sex, age, residence, and marital status of the users. Therefore, the result obtained by totaling the numbers of product inquiries for each category, which is estimated as shown in FIG. 3, can be managed in a state in which the result is divided according to sex, age, residence, and marital status. Accordingly, a keyword group including ten popular search queries, which belong to each category and of which the number of inquires is ranked high, can be managed in a state in which the total result is divided according to sex, age, residence, and marital status.

Furthermore, before a user inputs a search query to request a search result, user attribute information such as a connection region and a connection method of the user and whether or not the user has visited other websites is determined, and the numbers of product inquiries are totaled through a similar method to the above-described method, based on the user attribute information. Then, a plurality of search queries may be allocated to the respective categories. For example, the connection region of the user can be determined based on an Internet protocol (IP) address. Further, the connection method of the user can be determined according to the operation of a communication interface. That is, a device used when the user connects to the site, such as a mobile terminal, a desktop PC, or a wired terminal can be determined. Further, whether or not the user connects to the site by clicking a banner advertisement of another website can be determined. As such, the browsing behavior after the input of the search query is analyzed according to the user attribute information, and a keyword group including a plurality of search queries may be divided according to the connection region and connection method and whether the user has passed through other sites or not, and then allocated to each category. Therefore, the result obtained by totaling the number of product inquiries for each category, which is estimated as in FIG. 3, can be divided and managed according to the connection region and connection method and whether the user has passed through other sites or not. Accordingly, as shown in FIG. 4, a keyword group including ten popular search queries, which belong to each category and of which the inquiry numbers are ranked high, can be divided and managed according to the connection region and connection method and whether the user has passed through other sites or not.

When all the search queries belonging to the keyword group classified by the log in information and the user attribute information are sold to an advertiser in units of categories, advertisements targeted based on the user attribute information may be inserted. For example, when a search query within the sold category is received through a predetermined search window of the corresponding site after the user attribute information is determined, advertisement contents which are registered so as to be provided to only a user corresponding to the user attribute information may be provided at a proper position on a search result webpage. Further, even when contents within the sold category are selected on the search result webpage or a webpage displaying contents within another category, the advertisement contents which are registered so as to be provided to only a user corresponding to the user attribute information are provided on a detailed information webpage of the contents. Therefore, it is possible to increase the display frequency of the advertisement contents on various webpages browsed by the user.

In the present invention, the information on whether a user logs in or not can be used. Regardless of whether a user logs in or not, however, browsing behavior of a user after input of a search query may be analyzed, and a category to which the search query belongs may be determined. Then, a keyword group including a plurality of popular search queries may be made and managed for each category, and sold to an advertiser.

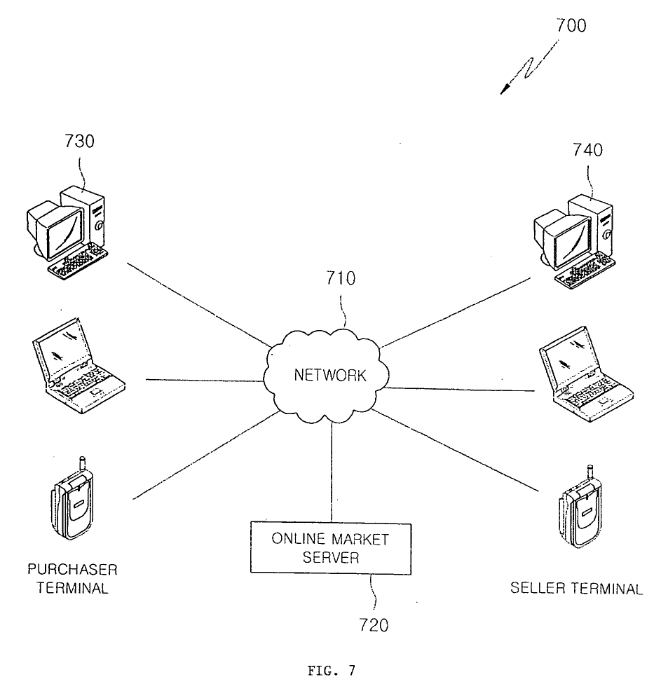

An example in which a keyword group for each category according to the present invention is operated in an online market system 700 shown in FIG. 7 will be described. Referring to FIG. 7, the online market system 700 may include a network 710, an online market server 620, a purchaser terminal 730, and a seller terminal 740.

The network 710 may be a wired or wireless Internet, a wired public network, a wireless mobile communication network, or a core network integrated with a mobile Internet. In the online market server 720 which relays product transactions between a seller and a purchaser on an online shopping mall through the network 710, various products sold by a seller are registered from the seller terminal 740 through the network 710. Further, the online market server 720 provides various products registered and managed for each category to the purchaser terminal 730 such that a purchaser can purchase a necessary product. The online market server 720 can process a payment for a product selected by the purchaser from a product list, and may provide the payment information to the seller such that the product can be delivered to the purchaser. Further, the online market server 720 can handle a process required for the delivery and can provide a location tracking service for the product which is being delivered.

In general, the seller and purchaser terminals 730 and 740 are computers such as a desktop PC or notebook PC. However, the seller and purchaser terminals 730 and 740 are not limited thereto, and all kinds of wired and wireless communication devices which can be connected to the online market server 720 through the network 710 so as to use an interactive product transaction relay service may be used as the seller and purchaser terminals 730 and 740. For example, the seller and purchaser terminals 730 and 740 may be mobile terminals such as cellular phones, personal communication service (PCS) phones, synchronous/non-synchronous internal mobile telecommunication 2000 (IMT-2000) terminals, which communicate over the mobile Internet. In addition, wired and wireless home appliance/communication devices such as palm PCs, personal digital assistants (PDA), smart phones, wireless application protocol (WAP) phones, mobile play stations and so on, which have a user interface for connecting to the online market server 720, may be used as the seller and purchaser terminals 730 and 740.

The seller and purchaser terminals 730 and 740 may be user terminals used for browsing the shopping mall operated by the online market server 720. The online market server 720 analyzes browsing behavior after a user inputs a search query, determines a category to which the search query belongs, and dynamically updates a keyword group for each category such that the category can be sold to an advertiser.

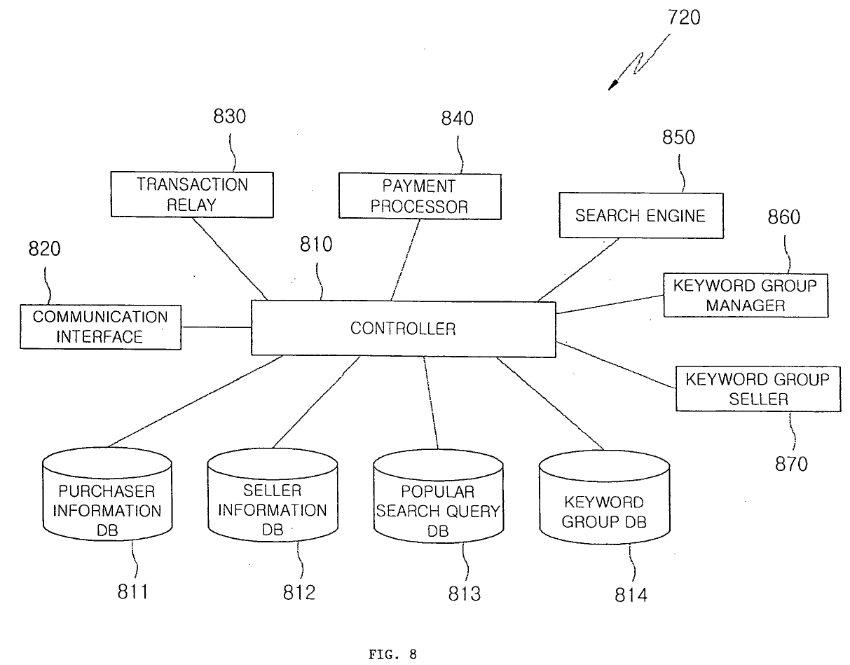

FIG. 8 is a block diagram of the online market server 720 according to the present invention. Referring to FIG. 8, the online market server 720 according to the present invention includes a controller 810, a purchaser information database (DB) 811, a seller information DB 812, a popular search query DB 813, a keyword group DB 814, a communication interface 820, a transaction relay 830, a payment processor 840, a search engine 850, a keyword group manager 860, and a keyword group seller 870.

The controller 810 controls product registration of a seller, product purchase of a purchaser, and delivery of a paid-for product in order to provide a product transaction relay service between the seller and the purchaser. The controller 810 corresponds to a processor which entirely controls the components of the online market server 720. Further, the controller 810 controls the provision of a webpage requested by a user terminal in order to support the generation, update, and sale of a keyword group for each category according to the present invention, and analyzes browsing behavior after a user inputs a search query, thereby determining a category to which the search query belongs. That is, the controller 810 can control the determination of a keyword group including a plurality of popular keywords which each belong to any one of the plurality of categories. Further, the controller 810 can perform control such that all search queries belonging to a keyword group can be sold to at least one advertiser in units of categories. When a search query within the category sold to an advertiser is input or a product or contents within the category is selected, advertisement contents registered when the category is sold can be provided on the webpage.

The seller terminal 740 can connect to the online market server 720 through the network 710. The product transaction relay service of the online market server 720 can be used through the seller terminal 740, according to wired and wireless communication processing performed by the communication interface 820. If necessary, a category (including all search queries belonging to a corresponding keyword group) can be purchased. A seller can join the site as a customer using the service of the online market server 720 through the seller terminal 740. Seller information registered by the seller having joined the site, for example, seller ID, password, contact address, product brand, prices of product to sell, features of the products, a category (including all search queries belonging to a corresponding keyword group) purchased for advertisement and so on may be stored in the seller DB 812.

The purchaser terminal 730 can connect to the online market server 720 through the network 710. The product transaction relay service of the online market server 720 can be used through the purchaser terminal 730, according to wired and wireless communication processing performed by the communication interface 820. A purchaser can join the site as a customer using the service of the online market server 720 through the purchaser terminal 730. Purchaser information registered by the purchaser who has joined the site, for example, purchaser ID, password, contact address, shopping basket information, information about products tendered, information about products on sale, information about bargain products, information about paid-for products, delivery information, information on whether or not to determine purchase, and so on, can be stored in the purchaser information DB 811.

The transaction relay 830 provides the product information stored in the seller information DB 812 to the purchaser terminal 730 through a webpage for each category as shown in FIG. 2, in order to relay the transaction of products registered by the seller. When the search engine 850 searches for a product corresponding to the search query from the purchaser terminal 730 based on the name or contents of the product, a product list can be provided to the purchaser terminal 730 through a search result webpage.

When a payment menu for a product which the purchaser wants to purchase is selected, the transaction relay 830 can provide payment screen information for the selected product to the purchaser terminal 730 through a webpage. The payment screen displayed on the purchaser terminal 730 based on the payment screen information may be configured in such a manner that the purchaser information (name, ID, phone number, etc.), information about products to be paid, payment amount, delivery place, payment method (credit card, deposit with passbook, real-time transfer, cyber money, etc.), and so on can be selected by the purchaser. After all the required information of the payment screen is filled in and checked, and when a final payment request is made by the purchaser, the payment processor 840 performs an authentication process using a certificate to settle the payment.

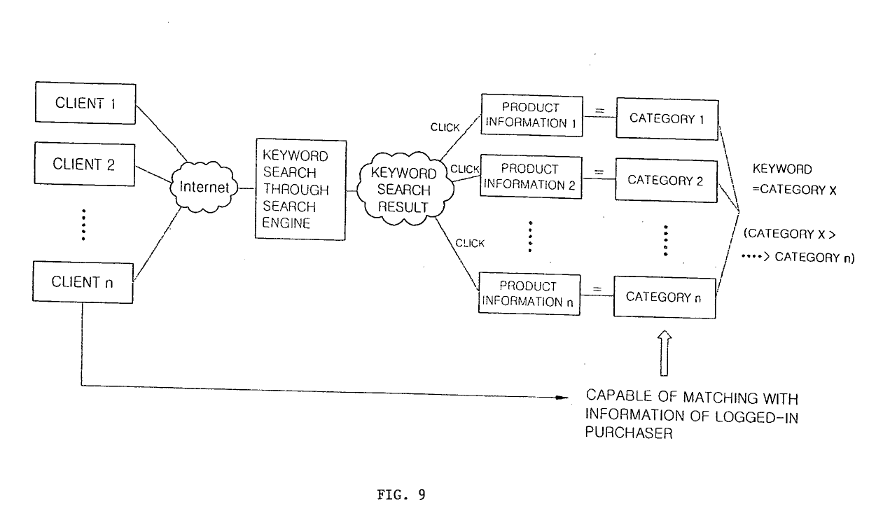

FIG. 9 is a diagram for explaining a process in which the number of product inquiries for a search keyword is totaled to determine a category.

Referring to FIG. 9, when the search engine 850 receives a search query from a client terminal such as a purchase terminal or seller terminal, the search engine 850 can provide information about products or contents that are managed for each category as shown in FIG. 2, on a search result webpage for the search query, through the transaction relay 830. In particular, to sell and manage the categories, the search engine 850 continuously counts input search queries and manages a plurality of popular search queries, for example, twenty thousand search queries, with a predetermined period, for example, every week, through the popular search query DB 813 such that the corresponding search queries can be allocated to keyword groups of the respective categories. Therefore, the recent search query tendency of users can be reflected in the keyword groups of the respective categories.

When a user inputs a search query and then browses a search result webpage while clicking on products and contents, the transaction relay 830 can provide a detailed information webpage of the product or contents selected by clicking based on the seller information DB 812. For example, the transaction relay 830 can provide production information 1 to n, as shown in FIG. 9.

When the user clicks and selects a product or contents while browsing or settles a payment on the detailed information webpage of the product, the keyword group manager 860 analyzes browsing behavior of the user. That is, the keyword group manager 860 determines which category the product clicked and selected by the user belongs to. For example, the keyword group manager 860 determines whether the product falls into a category X or not. Then, as shown in FIG. 3, the keyword manager 860 totals the number of product inquiries for the corresponding category. When the category X (computer/electronics of FIG. 2) includes sub-categories 1 to n (computer/monitor/printer, PC parts/peripheral devices and so on of FIG. 2), the numbers of product inquiries which are totaled for the sub-categories can be totaled for the category X. In this way, as described in FIG. 1, the keyword managing group 860 can total the numbers of product inquiries for a plurality of popular search queries which can be updated with a predetermined period. According to the total information of the totaled numbers, the respective search queries can be allocated to a category with a high-ranked inquiry number, as shown in FIG. 4. The keyword managing group 860 can classify the plurality of popular search queries into keyword groups with a predetermined period, for example, once per week, and then allocate the search queries to the respective categories. The information which is obtained by the keyword group managing group 860, as shown in FIG. 3, and the keyword group for each category shown in FIG. 4 can be stored in the keyword group DB 814.

Further, the keyword group manager 860 totals the number of product inquiries such that the number matches the user information such as a purchaser corresponding to the log in. When a plurality of search queries are allocated to the respective categories, the totaled numbers of product inquiries for the respective categories, which are estimated as shown in FIG. 3, may be divided according to the sex, age, residence, and marital status of users, and then stored and managed in the keyword group DB 814. Accordingly, as shown in FIG. 4, the number of product inquiries for the keyword group including ten popular search queries belonging to each category can be divided and managed according to the sex, age, residence, and marital status of users.

In addition, the keyword group manager 860 can determine user attribute information such as a connection region and connection method of a user inputting a search query and whether the user has passed through other sites or not. Accordingly, when a plurality of search queries are allocated to the respective categories based on the user attribute information, the result obtained by totaling the numbers of product inquiries for the respective categories can be divided according to the connection region, the connection method, and whether a user has passed through other sites or not, and then managed in the keyword group DB 814. Therefore, the number of product inquiries for the keyword group including ten popular search queries belonging to each category can be divided and managed according to the connection region, the connection method, and whether a user has passed through other sites or not.

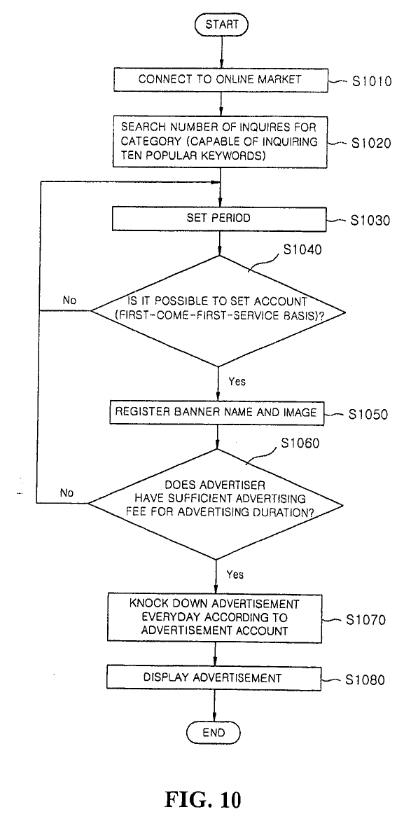

FIG. 10 is a diagram for explaining a purchasing process of a keyword group for advertisement.

For example, when an advertiser such as a seller connects to the online market server 720 to purchase a keyword group (step S1010), the keyword group seller 870 can present to the advertiser the result obtained by totaling the numbers of product inquiries as shown in FIG. 3 and a keyword group including ten popular search queries for each category which are managed as shown in FIG. 4, through a predetermined category purchase screen (step S1020). Further, a keyword group for each category, which is managed in a state in which a result obtained by totaling the number of inquires for the keyword group is divided according to sex, age, residence, and marital status, can be presented to the advertiser. In addition, a keyword group for each category, which is managed in a state in which a result obtained by totaling the number of product inquiries for the keyword group is divided and managed according to the connection region, the connection method, and whether a user has passed through other sites or not, can be presented to the advertiser. By referring to the presented information, the advertiser can purchase all search queries belonging to a category, that is, a keyword group which is closely related to the products and contents sold by the advertiser.

For example, when an advertiser such as a seller requests the purchase of a category by referring to the presented total information as shown in FIG. 3 and the keyword group for each category which is managed as shown in FIG. 4, the keyword group seller 870 can receive an advertisement period (or a plurality of advertisement periods) selected by the advertiser (S1030). Accordingly, the keyword group seller 870 can receive an account set by the advertiser for a date on which an advertisement account can be set (for example, account setting for each date), the advertisement account being set on a first-come-first-served basis (step S1040). Then, banner advertisement contents such as banner name, text, image, moving image or the like are input (step S1050). When the advertiser already possesses an expected advertising expenditure (online cash, credit card, deposit with passbook, real-time transfer, cyber money, etc.) for an advertising period, the keyword group purchased by the advertiser can be on sale to the advertiser at every designated day (step S1070). After all the information required for payment such as selection of category, advertising period, account, banner name, advertisement contents and so on are input on a predetermined category purchase screen, and when a payment method (credit card, deposit with passbook, real-time transfer, cyber money, etc.) is selected and the purchase of the corresponding keyword group is determined by the advertiser, the keyword group seller 870 stores the category sale information in the seller information DB 812 or an advertisement order reception DB, and the payment processor 840 may settle the payment after performing a required authentication procedure.

The category for all the queries belonging to the keyword group selected by the advertiser is on sale for each account on the corresponding date. Then, when a search query within the sold category is received through a predetermined search window, the keyword group seller 870 provides the advertisement contents registered when the category is sold on a search result webpage. Further, when a product within the sold category is selected, the keyword group seller 870 may provide the advertisement contents on a detailed information webpage of the product (step S1080).

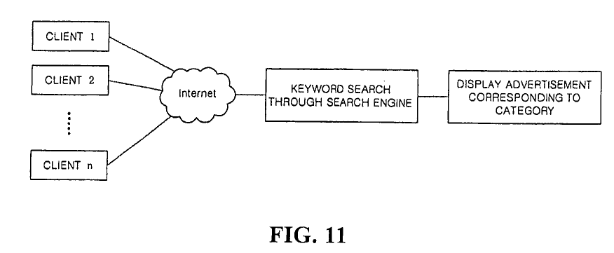

FIG. 11 is a diagram for explaining a process of exposing an advertisement for a purchased advertisement keyword group.

When a women's clothes trader has purchased a category of ‘women's clothes/underwear’ shown in FIG. 4, any one of popular search queries such as ‘summer’, ‘bikini’, ‘skirts’, . . . , ‘gift’ included in the keyword group belonging to the category may be input. In this case, the keyword group seller 870 can provide advertisement contents related to women's clothes, registered for the corresponding search query, on a search result webpage obtained by operation of the search engine 850. Further, when a client such as a purchaser selects a product such as ‘t-shirts’ or ‘skirts’ belonging to the category of ‘women's clothes/underwear’ on the search result webpage, the keyword group seller 870 can provide the advertisement contents related to women's clothes, registered for the search query, to the detailed information webpage of the product.

Although not shown, when a search query of ‘summer’ is input to the search window, various products which are related to the summer and managed for each category are displayed on a search result webpage. At this time, various advertisement contents related to women's clothes, which are registered by the advertiser, can be provided at proper positions of the search result webpage. For example, the popular search queries such as ‘summer’, ‘bikini’, ‘skirts’, ‘gift’ belonging to the category of ‘women's clothes/underwear’ may be sold to a cosmetics seller, or a plurality of advertisers who want their products to be advertised on webpages related to the category of ‘women's clothes/underwear’. At this time, although a search query belonging to the category of ‘women's clothes/underwear’ is input, an advertisement image registered by the advertiser may be provided on the search result webpage. Further, although not included in the keyword group of the category of ‘women's clothes/underwear’, products and contents such as blue jeans, cardigans, and bathing suits, which are managed under the category of ‘women's clothes/underwear’, may be provided as a search result on the search result webpage. At this time, when a product is clicked, the browsing behavior is analyzed to update a keyword group next time, and the advertisement contents related to women's clothes, registered by the women's clothes trader, can be displayed on the detailed information webpage of the product. As such, when the advertiser purchases the category including the keyword group, the display frequencies of various products managed under the corresponding category can be increased on a search result webpage by a related search query or on detailed information webpages.

The keyword group manager 860 manages the keyword groups of each category, which are divided according to the sex, age, residence, and marital status of a user, based on the user information corresponding to log in. Therefore, the keyword group seller 870 can sell all search queries belonging to a keyword group in units of categories, divided according to at least one of the sex, age, residence, and marital status of the user, to one or more advertisers. That is, to diversify an advertisement according to sex, age, residence, or marital status, the keyword group of each category shown in FIG. 4 may be divided according to sex, age, residence, and marital status. Then, the keyword groups of each category divided according to sex, age, residence, and marital status are targeted and managed in such a manner that each category can be sold. In this case, when a search query included in the sold category is input or contents included in the sold category are selected, advertisement contents registered when the category is sold to the advertiser can be provided in accordance with the sex, age, residence, and marital status of a user who has logged in to the webpage. For example, a seller selling products for people in their twenties may purchase a keyword group of a category, which is classified by age and managed. Then, only when a person in his/her twenties clicks a product, advertisement contents registered when the category is sold can be displayed on a webpage.

In addition, the keyword group manager 860 manages keyword groups of each category, which are divided according to a connection region and connection method of a user and whether the user has passed through other sites or not, based on the user attribute information. Therefore, the keyword group seller 870 can sell all search queries belonging to a keyword group in units of categories, the keyword group being classified according to at least one of the connection region and connection method of a user and whether the user has passed through other sites or not, to one or more advertisers. That is, to diversify advertisement according to the connection region or advertisers' selection according to the connection method and whether a user has passed through other sites or not, the keyword group of each category shown in FIG. 4 may be divided according to the connection region, the connection method, and whether a user has passed through other sites or not. Then, the keyword groups of each category divided according to the connection region, the connection method and whether a user has passed through other sites or not may be targeted and managed in such a manner that the category can be sold. In this case, when a search query included in the sold category is input or contents included in the sold category are selected, advertisement contents registered when the category is sold to the advertiser can be provided according to the connection region, the connection method, and whether a user has passed through other sites or not.

The functions used in the method and system disclosed in this specification can be implemented as computer-readable codes in a computer-readable recording medium. The computer-readable recording medium includes all kinds of recording devices which can store data read by computer systems. For the computer-readable recording medium, ROM, RAM, CD-ROM, a magnetic tape, a floppy disk, an optical data storing device, a hard disk, a movable storing device, and so on may be taken as examples. Further, a device implemented in the form of carrier waves (for example, transmission through the Internet) may be included. Further, the computer-readable recording medium can store and execute computer-readable codes which can be distributed among computer systems connected through a network.

According to the present invention, the website management method and system analyzes behavior of clicking or purchasing a product or contents after a user inputs a search query, dynamically updates a keyword group including a plurality of search queries having the same attribute information (category such as brand, theme, first-level classification, second-level classification, or third-level classification) into a database such that the search queries can be automatically managed, in order to receive an advertisement order for a category representing all search queries belonging to a keyword group and to display an advertisement whenever queries belonging to the corresponding category are input or information on products or contents is requested on a website which provides information on products or contents or relays transactions.

Further, the website management method and system can count search queries input by users on a website such as a shopping mall such that a predetermined number of popular search queries are automatically managed, can allocate the popular search queries to a category with a predetermined period (for example, every week) according to attribute information such that the category which reflects users' search query input tendencies is automatically managed, and can manage categories according to the sex, age, or residence of users such that when an advertiser purchases a desired category, an advertisement can be displayed with a high frequency on a webpage related to all keyword groups which are not concentrated on some popular search queries belonging to the corresponding category. Therefore, it is possible to increase a customer attraction. Further, since the advertisement is targeted at a related category, it is displayed to a greater number of customers a greater number of times, thereby making a deeper impression on customers. Therefore, it is possible to receive an advertisement order under more favorable conditions.

While the invention has been shown and described with reference to certain exemplary embodiments thereof, it will be understood by those skilled in the art that other various embodiments may be improved, changed, substituted, or added therein without departing from the spirit and scope of the invention as defined by the appended claims.

What is claimed is:

1. A website management method comprising:
receiving a search query and then analyzing browsing behavior for an information request for contents belonging to a certain category until another search query is input; and
determining a category to which the received search query belongs.

2. The website management method according to claim 1, wherein the category is attribute information for classifying contents.

3. The website management method according to claim 1, wherein the category includes sub-categories which classify contents at one or more levels.

4. The website management method according to claim 1, further comprising:
whenever a search query is input, repeatedly analyzing browsing behavior for the search query until another search query is input; and
determining a keyword group for each of a plurality of categories.

5. The website management method according to claim 4, wherein the input search queries are counted so as to update the plurality of search queries with a predetermined period, and
the keyword groups are updated at the predetermined period such that the plurality of search queries each belong to any one of the categories one time according to the browsing behavior analyzed for the search queries.

6. The website management method according to claim 4, further comprising:
selling all search queries belonging to the keyword group to at least one advertiser in units of categories; and
when a search query within a sold category is input or contents within a sold category are selected, providing advertisement contents registered when the category is sold on a corresponding webpage.

7. A website management method comprising:
determining a keyword group including a plurality of search queries which each belong to any one of a plurality of categories one time;
selling all the search queries belonging to the keyword group to at least one advertiser in units of categories; and
when a search query within a sold category is input or contents within a sold category are selected, providing advertisement contents registered when the category is sold on a corresponding webpage.

8. The website management method according to claim 7, further comprising:
updating the plurality of search queries with a predetermined period based on information obtained by counting the input search queries; and
updating the keyword group at the predetermined period based on browsing behavior analyzed for the plurality of search queries.

9. A website management method comprising:
receiving a search query;
providing a search result webpage for the search query;
selecting contents on the webpage at least one time;
providing a detailed information webpage of the selected contents;
determining a category to which the selected contents belong and then totaling the number of inquires for the category; and
totaling the numbers of contents inquires for the plurality of search queries, periodically classifying the plurality of search queries into keyword groups, and allocating the search queries to the respective categories.

10. The website management method according to claim 9, further comprising: when all search queries belonging to the keyword group are sold to at least one advertiser in units of categories and a search query within the sold category is received, providing advertisement contents registered when the category is sold on the search result webpage; and
when the contents within the sold category are selected, providing the advertisement contents on a detailed information webpage of the contents.

11. The website management method according to claim 9, further comprising:
determining user attribute information, before the receiving of the search query; and
totaling the number of contents inquires based on the user attribute information and then allocating the plurality of search queries to the respective categories.

12. The website management method according to claim 11, further comprising:
when the plurality of search queries are allocated to the respective categories according to at least one of a connection region, a connection method, and whether a user has passed through other sites or not, and all search queries belonging to a corresponding keyword group are sold to at least one advertiser in units of categories classified according to at least one of a connection region, a connection method, and whether a user has passed through other sites or not, and
when a search query within the sold category is received from a user, providing the advertisement contents registered when the category is sold on a corresponding search result webpage; and
when the contents within the sold category are selected by the user, providing the advertisement contents on a detailed information webpage of the contents.

13. A recording medium which stores a computer-readable program for performing the method according to any one of claims 1 to 12.

14. An online system comprising:
an online server that manages a webpage on the Internet, the online server including a controller which receives a search query, analyzes browsing behavior for an information
request for contents belonging to a certain category until another search query is input, and
determines a category to which the search query belongs.

15. An online system comprising:
an online server that manages a webpage on the Internet, the online server including a controller which controls the provision of a webpage requested by a user terminal and the determination of a keyword group including a plurality of search queries which each belong to any one of a plurality of categories one time,
wherein the controller performs control such that all the search queries belonging to the keyword group are sold to at least one advertiser in units of categories, and
when a search query within a sold category is input or contents within a sold category are selected, the controller provides to a corresponding webpage advertisement contents registered when the category is sold.

16. The online system according to claim 15, wherein the online server includes an online market server which manages one or more products as contents for each category, and relays the transaction of the products.

17. An online market system comprising:
a search engine that receives a search query and provides a search result webpage for the search query;
a transaction relay that provides a detailed information webpage of a product when the product is selected on the webpage; and
a keyword group manager that determines a category to which the selected product belongs and then totals the number of product inquiries for the corresponding category,
wherein the keyword group manager totals the numbers of product inquiries for the plurality of search queries, periodically classifies the plurality of search queries as a keyword group, and allocates the search queries to the respective categories.

18. The online market system according to claim 17, wherein the search engine manages the plurality of search queries with a predetermined period by counting the input search queries, and updates the plurality of search queries as the plurality of search queries.

19. The online market system according to claim 17, further comprising:
a keyword group seller that sells all search queries belonging to the corresponding keyword group to at least one advertiser in units of categories,
wherein when a search query within the sold category is received, the keyword group seller provides to the search result webpage advertisement contents registered when the category is sold, and
when a product within the sold category is selected, the keyword group seller provides the advertisement contents on a detailed information webpage of the product.

20. The online market system according to claim 19, wherein the keyword group manager determines at least one piece of user attribute information among a connection region and connection method of a user and whether the user has passed through other sites or not, totals the number of product inquiries for the connection region and connection method of the user and whether the user has passed through other sites or not, according to the user attribute information, and allocates the plurality of search queries to the respective categories, and
in the event that all search queries belonging to a corresponding keyword group are sold to at least one advertiser in units of categories classified according to at least one of the connection region, the connection method, and whether a user has passed through other sites or not,
when a search query within the sold category is received from the user, the keyword group seller provides advertisement contents registered when the category is sold on a corresponding search result webpage, and
when a product within the sold category is selected by the user, the keyword group seller provides the advertisement contents on a detailed information webpage of the product.
